(19) United States
(12) Patent Application Publication
(10) Pub. No.: US 2002/0131327 A1
(43) Pub. Date: Sep. 19, 2002

(54) Adjustable baffle device secured to a wall of a container of a vertical mixer for processing and mixing materials such as animal feed and the like

(76) Inventors: Christopher Albright, Brodhead, WI (US); Ric Joranlien, Monroe, WI (US)

Correspondence Address: DAVID J. ARCHER, 9790 FOREST PRESERVE RD., DURAND, IL, 61024, US

(21) Appl. No.: 09/808,592

(22) Filed: Mar. 14, 2001

(51) Int. Cl. B01F 7/24

(52) U.S. Cl. 366/307; 366/314; 366/603

(57) ABSTRACT

An adjustable baffle device secured to a wall of a container of a vertical mixer for processing and mixing materials such as animal feed and the like is disclosed. The device includes an elongated plate having a first and a second end, the plate being secured to the wall of the container about a pivot disposed between the first and second ends of the plate. The plate has a first portion disposed between the pivot and the first end of the plate and a second portion disposed between the pivot and the second end of the plate. The first portion is disposed above the second portion the arrangement being such that, in a first mode of operation, when the plate is pivoted about the pivot so that the first portion of the plate extends into the container to baffle a flow of the materials within the container, processing of the materials is accomplished and in a second mode of operation thereof, when the plate is pivoted about the pivot so that the second portion of the plate extends into the container to baffle the flow of the materials within the container, the mixing of the materials is accomplished.

### BACKGROUND OF THE INVENTION

1. Field of the Invention

The present invention relates to a baffle device for processing and mixing materials such as animal feed and the like. More specifically, the present invention relates to a baffle device for processing and mixing materials such as animal feed and the like in a vertical mixer.

2. Information Disclosure Statement.

During cattle farming , various livestock feeds are mixed and subsequently distributed. Additionally, mixers can be used for mixing other materials such as composts and the like. Sometimes such mixing of feeds includes depositing at least one bale of hay into a mixer container together with other additives. The materials within the container are mixed by means of at least one auger which rotates within the container so that an intimate mixing of the contents of the container is obtained. Although many mixers employ a pair of horizontal interacting augers extending longitudinally along the container, several mixers have been proposed in which the auger or augers are disposed vertically.

Such mixing in a vertical auger mixer generally consists of two operations. The first operation includes processing of long stem hay into shorter length pieces. The second operation includes the addition and mixing of the balance of the feed ingredients. In order to achieve the aforementioned operations, baffle devices have been proposed. These baffle devices or hay dogs as they are sometimes called, are generally used for restricting the movement of hay during the processing and/or mixing operation. Depending on the type of material being processed and mixed, the position of the baffle may need to be adjusted to produce optimal operation. Also, several baffles may be required at various elevations within the container.

Also, in the prior art, it is known that sliding adjustable baffle plates into the mixing container of a vertical mixer affects the movement of the material in the container. Different materials require different movement in the container for optimal processing and mixing.

Additionally, it is known that the amount of baffle extending into the container affects the movement of material in the container. Known baffles provide a pivoting baffle that has 3 to 4 positions ranging from no baffle in the container to a maximum extension of 6 inches into the container. However, the baffle pivots at one end and the other end of the baffle rotates into the container.

Although, it is known that the vertical positioning of the pivoting baffle on the wall of the container affects the movement of the material in the container, no one, so far as Applicant is aware, has utilized a baffle that can enter the container at either a high or a low vertical position.

Furthermore, known baffles include manual means for rotating the baffle or an actuator for rotating such baffle in and out of the container.

The present invention overcomes the need for multiple baffle devices and the like by the provision of a pivoted baffle device which has a high and a low position. The high position generally permits processing of the hay while the low position generally enables an operator to mix the processed hay with various additives. Moreover, the high and low positions allow more flexibility in adjusting the flow of hay and feed material inside the mixer container. Normally, in the absence of a baffle, the material within the container tends to flow around the wall in the circular direction of the auger rotation. However, the insertion into the container of a baffle causes a restriction of such flow of the feed around the wall in the circular direction of the auger rotation.

Therefore, it is a primary feature of the present invention to provide a baffle device which overcomes the aforementioned problems associated with the prior art baffle devices and which makes a significant contribution to the art of processing and mixing materials such as animal feeds and the like.

Another feature of the present invention is the provision of a baffle device having a first disposition for generally processing hay and the like and a second disposition for generally mixing processed hay with various additives.

Other features and advantages of the present invention will be readily apparent to those skilled in the art by a consideration of the detailed description contained herein with reference to the annexed drawings which show a preferred embodiment of the present invention.

### SUMMARY OF THE INVENTION

The present invention relates to an adjustable baffle device secured to a wall of a container of a vertical mixer for processing and mixing materials such as animal feed and the like. The device includes an elongated plate having a first and a second end, the plate being secured to the wall of the container about a pivot disposed between the first and second ends of the plate. The plate has a first portion disposed between the pivot and the first end of the plate and a second portion disposed between the pivot and the second end of the plate. The first portion is disposed above the second portion the arrangement being such that, in a first mode of operation, when the plate is pivoted about the pivot so that the first portion of the plate extends into the container to baffle a flow of the materials such as animal feed within the container, processing of the materials is accomplished and in a second mode of operation thereof, when the plate is pivoted about the pivot so that the second portion of the plate extends into the container to baffle the flow of the materials within the container, the mixing of the materials is accomplished.

In a further aspect of the present invention, the device also includes pivoting means which may be a lever having a first and a second extremity. The first extremity of the lever is pivotally secured to the plate about a further pivot disposed spaced relative to the pivot. The further pivot is disposed between the first and second ends of the plate. The device is structured and arranged such that in use of the device, in the first mode of operation thereof, the lever is moved in a first direction for pivoting the plate about the pivot so that the first portion of the plate extends into the container to baffle flow of the materials such as animal feed within the container so that the flow of the materials is altered. In a second mode of operation of the baffle device, the lever is moved in a second direction for pivoting the plate about the pivot so that the second portion of the plate extends into the container to baffle the flow of the materials within the container so that the flow of the materials is again altered.

In a more specific embodiment of the present invention, the plate is fabricated from steel and is disposed substantially normal to the wall of the container. The plate pivots about the pivot which has a pivotal axis disposed substantially horizontally, the pivotal axis extending tangentially to the wall of the container. Also, the plate pivots within a slot defined by the wall of the container.

The first portion includes a baffle edge for the processing of the materials such as animal feed and a top edge disposed adjacent to the baffle edge and the first end of the plate and disposed remote from the pivot. An outside edge is disposed remote from the baffle edge, the outside edge extending from the top edge and a side extends between the outside edge and the baffle edge such that the pivot and further pivot are disposed along the side.

Furthermore, the pivot is disposed between the further pivot and the baffle edge.

The second portion includes a further baffle edge for the mixing of the materials such as animal feed and a bottom edge which is disposed adjacent to the further baffle edge and the second end of the plate and disposed remote from the pivot. A further outside edge is disposed remote from the further baffle edge, the further outside edge extending from the bottom edge. Also, a further side extends between the further outside edge and the further baffle edge such that the pivot and further pivot are disposed along the further side, the further side and the side being contiguous. Additionally, the pivot is disposed between the further pivot and the further baffle edge.

In an alternative arrangement, according to the present invention, the pivoting means includes an actuator which is secured to the container wall and the plate and arranged such that when the actuator is in a first disposition thereof, the actuator is moved in the first direction and when the actuator is in a second disposition thereof, the actuator is moved in the second direction for pivoting the plate.

In another embodiment of the present invention, the pivoting means is a handle slidably disposed relative to the wall of the container. The handle is arranged such that when the handle is in a first disposition thereof, the handle is moved in the first direction and when the handle is in a second disposition thereof, the handle is moved in the second direction for pivoting the plate.

Additionally, the baffle edge and the further baffle edge define therebetween an obtuse angle or alternatively, such edges may lie on a straight line.

Many modifications and variations of the present invention will be readily apparent to those skilled in the art by a consideration of the detailed description contained hereinafter. However, such modifications and variations fall within the spirit and scope of the present invention as defined by the appended claims.

### BRIEF DESCRIPTION OF THE DRAWINGS

FIG. 1 is a perspective view of a vertical mixer having a container with a baffle device according to the present invention secured to a wall of the container;

FIG. 2 is an enlarged elevational view of the baffle device shown in FIG. 1;

FIG. 3 is a similar view to that shown in FIG. 2. However, in FIG. 3, the baffle device is moved for mixing the feed;

FIG. 4 is a similar view to that shown in FIGS. 2 and 3 but shows a further embodiment of the present invention;

FIG. 5 is a similar view to that shown in FIG. 2 but shows a preferred embodiment of the present invention;

FIG. 6 is a similar view to that shown in FIG. 5 but shows the plate pivoted for processing the materials; and

FIG. 7 is a fragmentary view taken on the line 7-7 of FIG. 6.

Similar reference characters refer to similar parts throughout the various embodiments shown in the drawings.

### DETAILED DESCRIPTION OF THE DRAWINGS

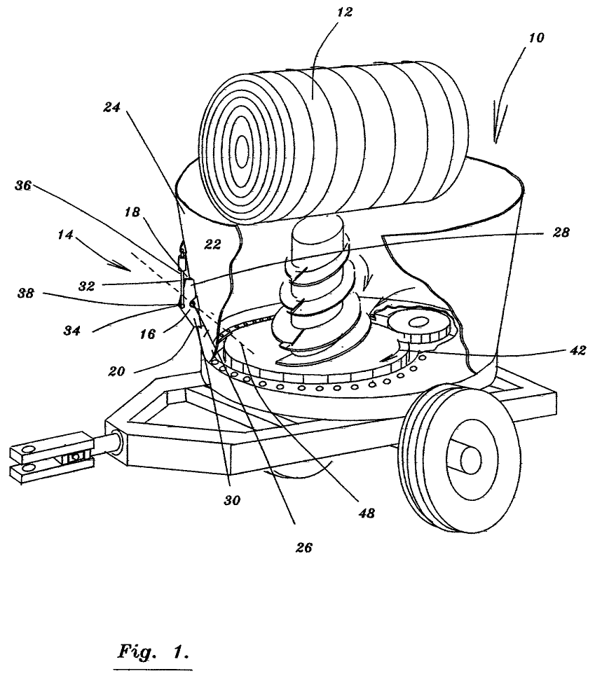

FIG. 1 is a perspective view of a vertical mixer having a container with a baffle device according to the present invention secured to a wall of the container. As shown in FIG. 1 the vertical mixer generally designated 10 is for processing and mixing materials such as animal feed 12 and the like. The baffle device generally designated 14 according to the present invention includes an elongated plate generally designated 16 having a first and a second end 18 and 20 respectively. The plate 16 is secured to the wall 22 of the container 24 about a pivot 26 disposed between the first and second ends 18 and 20 respectively of the plate 16. The plate 16 includes a first portion 28 which is disposed between the pivot 26 and the first end 18 of the plate 16. A second portion 30 is disposed between the pivot 26 and the second end 20 of the plate 16, the first portion 28 being disposed above the second portion 30. The baffle device 14 also includes a pivoting means 32 which may be a lever, a handle or an actuator. The pivoting means such as a lever has a first and a second extremity 34 and 36 respectively. The first extremity 34 of the lever 32 is pivotally secured to the plate 16 about a further pivot 38 disposed spaced relative to the pivot 26. The further pivot 38 is disposed between the first and second ends 18 and 20 respectively of the plate 16.

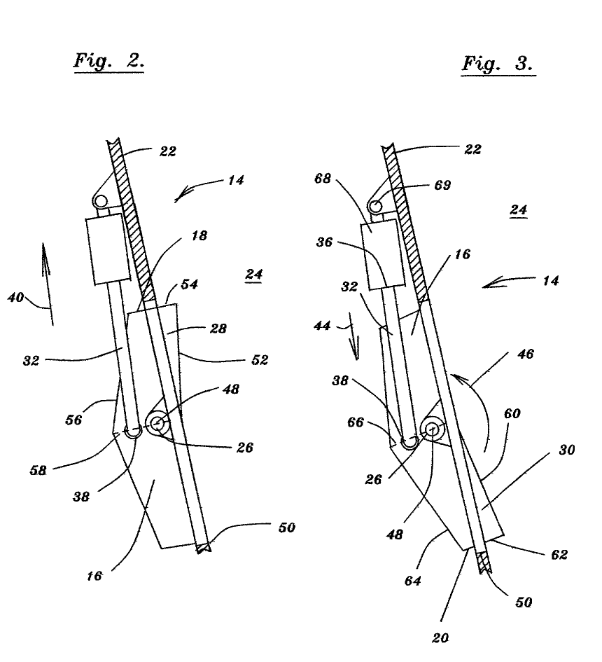

FIG. 2 is an enlarged elevational view of the baffle device 14 shown in FIG. 1. As shown in FIG. 2, the baffle device 14 is structured and arranged such that in use of the device 14, in a first mode of operation thereof as shown in FIG. 2, the lever 32 is moved in a first direction as indicated by the arrow 40 for pivoting the plate 16 about the pivot 26 so that the first portion 28 of the plate 16 extends into the container 24 to baffle a flow as indicated by the arrow 42 of the materials such as animal feed 12 within the container 24, as shown in FIG. 1, so that the processing of the materials 12 is accomplished. Accordingly, FIG. 2 shows the baffle device in the “high” position thereof.

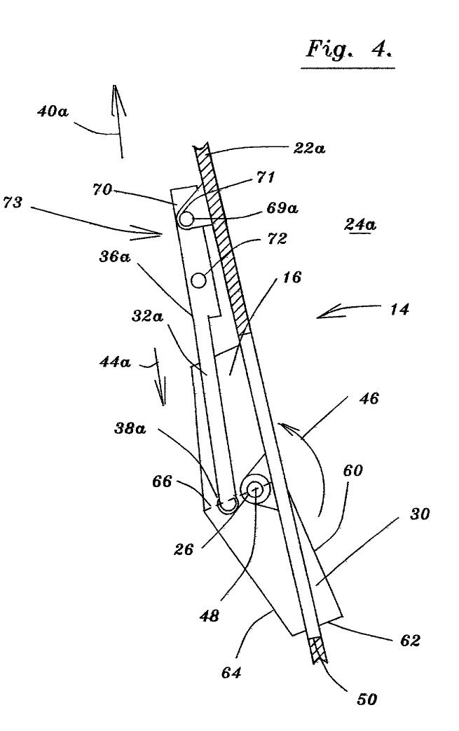

FIG. 3 is a similar view to that shown in FIG. 2. However, in FIG. 3, the baffle device 14 is moved for mixing the feed 12. As shown in FIG. 3, in a second mode of operation of the baffle device 14, the lever 32 is moved in a second direction as indicated by the arrow 44 for pivoting the plate 16 about the pivot 26 as indicated by the arrow 46 so that the second portion 30 of the plate 16 extends into the container 24 to baffle the flow 42 of the materials such as animal feed 12 within the container 24, as shown in FIG. 1, so that the mixing of the materials 12 is accomplished. Therefore, FIG. 3 shows the baffle device 14 in the low position thereof.

In a more specific embodiment of the present invention, the plate 16 is fabricated from steel and is disposed substantially normal to the wall 22 of the container 24. The plate 16 pivots about the pivot 26 which has a pivotal axis 48 disposed substantially horizontally, the pivotal axis 48 extending tangentially to the wall 22 of the container 24 as shown in FIG. 1. Also, the plate 16 pivots within a slot 50 defined by the wall 22 of the container 24.

The first portion 28 includes a baffle edge 52, shown in FIG. 2, for the processing of the materials 12 and a top edge 54 disposed adjacent to the baffle edge 52 and the first end 18 of the plate 16 and disposed remote from the pivot 26. An outside edge 56 is disposed remote from the baffle edge 52, the outside edge 56 extending from the top edge 54 and a side 58 extends between the outside edge 56 and the baffle edge 52 such that the pivot 26 and further pivot 38 are disposed along the side 58. Furthermore, the pivot 26 is disposed between the further pivot 38 and the baffle edge 52.

The second portion 30 includes a further baffle edge 60, shown in FIG. 3, for the mixing of the materials 12 and a bottom edge 62 which is disposed adjacent to the further baffle edge 60 and the second end 20 of the plate 16 and disposed remote from the pivot 26. A further outside edge 64 is disposed remote from the further baffle edge 60, the further outside edge 64 extending from the bottom edge 62. Also, a further side 66 extends between the further outside edge 64 and the further baffle edge 60 such that the pivot 26 and further pivot 38 are disposed along the further side 66, the further side 66 and the side 58 being contiguous. The pivot 26 is disposed between the further pivot 38 and the further baffle edge 60.

In an alternative embodiment of the present invention, the pivoting means 32 may be an actuator 68. The actuator 68 may be a hydraulic, electrical or pneumatic actuator. The actuator 68 is pivotally secured about a pivot pin 69 to the container wall 22 and arranged such that when the actuator 68 is in a first disposition thereof, as shown in FIG. 2, the actuator 68 is moved in the first direction 40. However, when the actuator 68 is in a second disposition thereof, as shown in FIG. 3, the actuator 68 is moved in the second direction 44 for pivoting the plate 16.

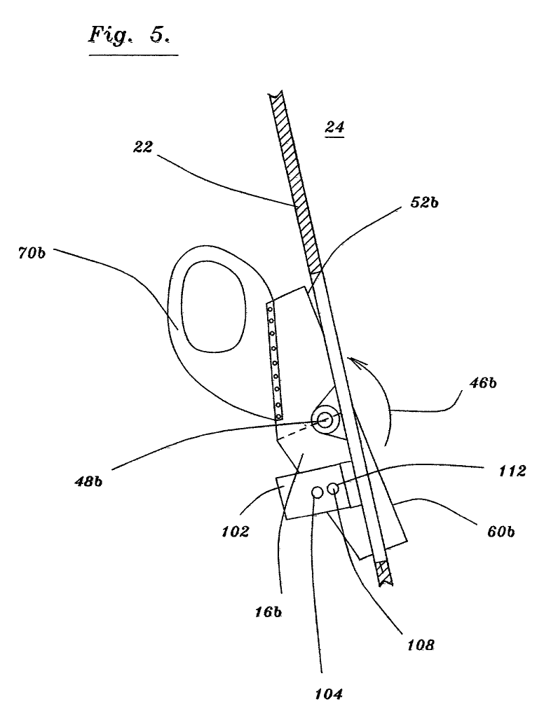

FIG. 4 is a similar view to that shown in FIGS. 2 and 3 but shows a further embodiment of the present invention. As shown in FIG. 4, a handle 70 is pivotally connected to a further pivot 38a. The handle 70 is arranged such that when the handle 70 is in a first disposition thereof, the handle 70 is moved in the first direction 40a. However, when the handle 70 is in a second disposition thereof, the handle 70 is moved in the second direction 44a. A locking means generally designated 73 includes a pin 69a which engages a hole 71 in the handle 70 as shown in FIG. 4. However, in the first disposition of the handle 70, for processing, the pin 69a engages a further hole 72 defined by the handle.

Additionally, in both of the aforementioned embodiments of the present invention, the baffle edge 52 and the further baffle edge 60 define therebetween an obtuse angle. Alternatively, the edges 52 and 60 could lie along the same straight line.

Those skilled in the art will appreciate that the present invention would also include an arrangement in which the baffle edge 52 and the further baffle edge 60 define therebetween an angle that is greater than 180 degrees. However, this would not be the preferred arrangement.

FIG. 5 is a similar view to that shown in FIG. 2 but shows a preferred embodiment of the present invention in which the edges 52b and 60b both lie along a straight line. Also, as shown in FIG. 5, a handle 70b is rigidly secured to the plate 16b. The arrangement is such that when the handle 70b is pulled away from the wall 22 of the container 24, the plate 16b pivots about the pivotal axis 48b as indicated by the arrow 46b so that further baffle edge 60b protrudes into the flow of materials so that mixing of the materials is carried out.

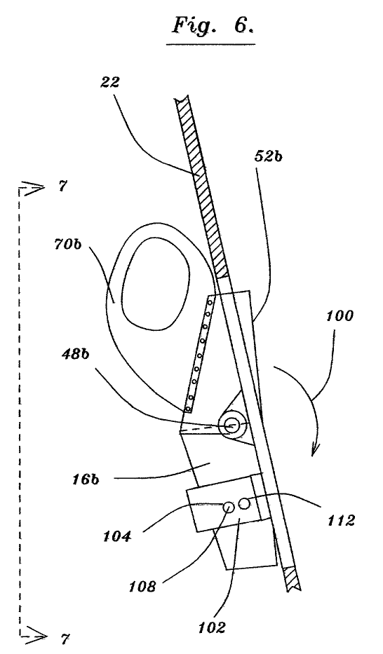

FIG. 6 is a similar view to that shown in FIG. 5 but shows the plate 16b pivoted for processing the materials. As shown in FIG. 6, when the handle 70b is moved towards the wall 22, the plate 16b pivots about pivotal axis 48b as indicated by arrow 100 such that the baffle edge 52b protrudes into the container for processing the materials.

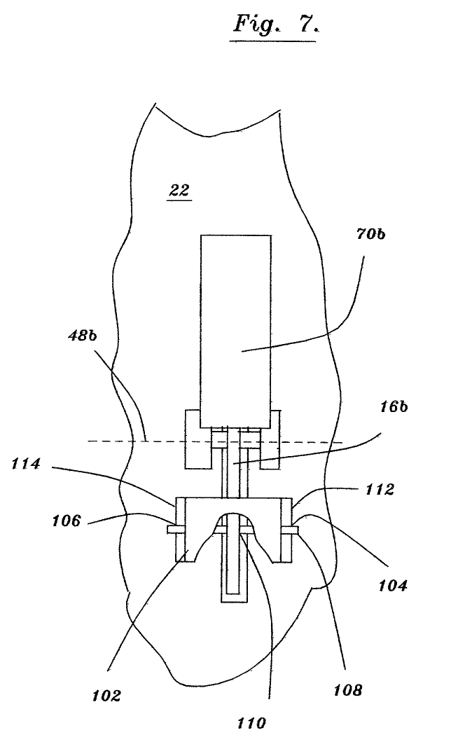

FIG. 7 is a fragmentary view taken on the line 7-7 of FIG. 6. As shown in FIG. 7, a saddle shaped bracket 102 is secured to the wall 22. The bracket 102 defines a first and second aperture 104 and 106 for the reception therethrough of a locking pin 108. The pin 108 also extends through an opening 110 defined by the plate 16b so that when the apertures 104 and 106 and the opening 110 are aligned and the pin 108 extends therethrough, the plate 16b is locked in the processing disposition thereof.

However when the pin 108 extends through aligned apertures 112 and 114 defined by the bracket 102 and through the opening 110 of the plate 16b, the plate 16b is locked in the mixing disposition thereof. Other holes may be provided in the bracket 102 so that various processing and mixing operations may be accomplished.

In operation of the baffle device according to the present invention, in all of the embodiments of the invention as shown in FIGS. 1-6., the plate 16 is pivoted about pivot 26 so that the first portion 28 extends into the container 24 for processing the hay or like material as particularly shown in FIG. 2.

Moreover, when the plate 16 is pivoted about pivot 26 as indicated by the arrow 46, so that the second portion 30 extends into the container 24, mixing materials such as hay is accomplished as shown in FIG. 3.

The present invention provides a unique baffle device secured to a wall of the container of a vertical mixer for processing and mixing materials such as animal feed and the like.

What is claimed is:

1. An adjustable baffle device secured to a wall of a container of a vertical mixer for processing and mixing materials such as animal feed and the like, said device comprising:
an elongated plate having a first and a second end, said plate being secured to the wall of the container about a pivot disposed between said first and second ends of said plate;
said plate including:
a first portion disposed between said pivot and said first end of said plate; and
a second portion disposed between said pivot and said second end of said plate, said first portion being disposed above said second portion, the arrangement being such that, in a first mode of operation, when said plate is pivoted about said pivot so that said first portion of said plate extends into the container to baffle a flow of the materials within the container, processing of the materials is accomplished and in a second mode of operation thereof, when said plate is pivoted about said pivot so that said second portion of said plate extends into the container to baffle the flow of the materials within the container, the mixing of the materials is accomplished.

2. A baffle device as set forth in claim 1 further including:
pivoting means secured to said plate, said pivoting means having a first and a second extremity, so that when said pivoting means is moved in a first direction for pivoting said plate about said pivot, said first portion of said plate extends into the container to baffle said flow of the materials within the container such that the processing of the materials is accomplished and so that when said pivoting means is moved in a second direction for pivoting said plate about said pivot, said second portion of said plate extends into the container to baffle said flow of the materials within the container such that the mixing of the materials is accomplished.

3. A baffle device as set forth in claim 2 wherein
said first extremity of said pivoting means is pivotally secured to said plate about a further pivot disposed spaced relative to said pivot, said further pivot being disposed between said first and second ends of said plate, the device being structured and arranged such that in use of the device, in said first mode of operation thereof, said first portion of said plate extends into the container to baffle said flow of the materials within the container such that the processing of the materials is accomplished and in said second mode of operation thereof, said second portion of said plate extends into the container to baffle said flow of the materials within the container such that the mixing of the materials is accomplished.

4. A baffle device as set forth in claim 2 wherein
said pivoting means is a lever

5. A baffle device as set forth in claim 1 wherein
said plate is fabricated from steel.

6. A baffle device as set forth in claim 1 wherein
said plate is disposed substantially normal to the wall of the container.

7. A baffle device as set forth in claim 1 wherein
said plate pivots about said pivot which has a pivotal axis disposed substantially horizontally.

8. A baffle device as set forth in claim 7 wherein
said pivotal axis extends tangentially to the wall of the container.

9. A baffle device as set forth in claim 1 wherein
said plate pivots within a slot defined by the wall of the container.

10. A baffle device as set forth in claim 1 wherein
said first portion includes:
a baffle edge for the processing of the materials;
a top edge disposed adjacent to said baffle edge and said first end of said plate and disposed remote from said pivot;
an outside edge disposed remote from said baffle edge, said outside edge extending from said top edge;
a side extending between said outside edge and said baffle edge such that said pivot is disposed along said side.

11. A baffle device as set forth in claim 10 wherein
both said pivot and a further pivot are disposed along said side.

12. A baffle device as set forth in claim 10 wherein
said pivot is disposed between a further pivot and said baffle edge.

13. A baffle device as set forth in claim 10 wherein
said second portion includes:
a further baffle edge for the mixing of the materials;
a bottom edge disposed adjacent to said further baffle edge and said second end of said plate and disposed remote from said pivot;
a further outside edge disposed remote from said further baffle edge, said further outside edge extending from said bottom edge;
a further side extending between said further outside edge and said further baffle edge such that said pivot is disposed along said further side, said further side and said side being contiguous.

14. A baffle device as set forth in claim 13. wherein
both said pivot and a further pivot are disposed along said further side.

15. A baffle device as set forth in claim 13 wherein
said pivot is disposed between said further pivot and said further baffle edge.

16. A baffle device as set forth in claim 2 wherein
said pivoting means is an actuator pivotally secured to said plate about a further pivot.

17. A baffle device as set forth in claim 1 further including:
a handle connected to said plate for manually pivoting said plate.

18. A baffle device as set forth in claim 17 further including:
locking means associated with said handle for locking said plate against pivoting thereof.

19. A baffle device as set forth in claim 13 wherein
said baffle edge and said further baffle edge define therebetween an obtuse angle.

20. A baffle device secured to a wall of a container of a vertical mixer for processing and mixing materials such as animal feed and the like, said device comprising:
an elongated plate having a first and a second end, said plate being secured to the wall of the container about a pivot disposed between said first and second ends of said plate;
said plate including:
a first portion disposed between said pivot and said first end of said plate;
a second portion disposed between said pivot and said second end of said plate, said first portion being disposed above said second portion;
a lever having a first and a second extremity, said first extremity of said lever being pivotally secured to said plate about a further pivot disposed spaced relative to said pivot, said further pivot being disposed between said first and second ends of said plate, the device being structured and arranged such that in use of the device, in a first mode of operation thereof, said lever is moved in a first direction for pivoting said plate about said pivot so that said first portion of said plate extends into the container to baffle a flow of the materials within the container so that the processing of the materials is accomplished and in a second mode of operation thereof, said lever is moved in a second direction for pivoting said plate about said pivot so that said second portion of said plate extends into the container to baffle the flow of the materials within the container so that the mixing of the materials is accomplished; and
said plate pivoting about a horizontal axis within a slot defined by the wall of the container.

21. A baffle device secured to a wall of a container of a vertical mixer for processing and mixing materials such as animal feed and the like, said device comprising:
an elongated plate having a first and a second end, said plate being secured to the wall of the container about a pivot disposed between said first and second ends of said plate;
said plate including:
a first portion disposed between said pivot and said first end of said plate;
a second portion disposed between said pivot and said second end of said plate, said first portion being disposed above said second portion;
a lever having a first and a second extremity, said first extremity of said lever being pivotally secured to said plate about a further pivot disposed spaced relative to said pivot, said further pivot being disposed between said first and second ends of said plate, the device being structured and arranged such that in use of the device, in a first mode of operation thereof, said lever is moved in a first direction for pivoting said plate about said pivot so that said first portion of said plate extends into the container to baffle a flow of the materials within the container so that the processing of the materials is accomplished and in a second mode of operation thereof, said lever is moved in a second direction for pivoting said plate about said pivot so that said second portion of said plate extends into the container to baffle the flow of the materials within the container so that the mixing of the materials is accomplished; and
an actuator secured to said second extremity of said lever, said actuator being secured to the container wall and arranged such that when said actuator is in a first disposition thereof, said lever is moved in said first direction for processing the materials and when said actuator is in a second disposition thereof, said lever is moved in said second direction for mixing the materials.
